(19) United States
(12) Patent Application Publication
(10) Pub. No.: US 2003/0021449 A1
(43) Pub. Date: Jan. 30, 2003

(54) Image transmission system and method for camera apparatus and viewer apparatus

(76) Inventor: Stephen Bernard Pollard, Uley Nr Dursley (GB)

Correspondence Address: HEWLETT-PACKARD COMPANY, Intellectual Property Administration, P.O. Box 272400, Fort Collins, CO, 80527-2400, US

(21) Appl. No.: 10/200,492

(22) Filed: Jul. 23, 2002

(30) Foreign Application Priority Data
Jul. 27, 2001 (GB) 0118445.6

(51) Int. Cl. G06K 9/00; G06F 7/00

(52) U.S. Cl. 382/118; 707/10

(57) ABSTRACT

An image transmission system comprises a camera apparatus arranged to provide camera images and a viewer apparatus. The viewer apparatus is arranged to receive the camera images from the camera apparatus and to determine that the camera images are being displayed on a viewing display and that a viewing operator is present to view the viewing display, and in return provides a viewer indication signal indicating that the camera images are received. The camera apparatus comprises a viewer indicator operable to indicate that camera images are received by the viewer apparatus, the viewer indicator being operable in response to the viewer indication signal from the viewer apparatus. A method of operating such a system is described, as is a viewing apparatus adapted for this purpose.

### FIELD OF THE INVENTION

The present invention relates in general to an image transmission system and to a method for transmitting camera images.

### BACKGROUND TO INVENTION

In systems involving camera apparatus and viewing apparatus, it may be advantageous for the user (or subject) of the camera apparatus to determine whether images produced by a camera apparatus are received by a viewer apparatus.

### SUMMARY OF THE INVENTION

According to a first aspect of the present invention there is provided an image transmission system, comprising: a camera apparatus arranged to provide camera images; and a viewer apparatus arranged to receive the camera images from the camera apparatus and arranged to determine that the camera images are being displayed on a viewing display and that a viewing operator is present to view the viewing display, and in return providing a viewer indication signal indicating that the camera images are received; wherein the camera apparatus comprises a viewer indicator operable to indicate that camera images are received by the viewer apparatus, the viewer indicator being operable in response to the viewer indication signal from the viewer apparatus.

It is desirable to know that images received at a viewer apparatus are being viewed by a viewing operator. Preferably, the viewer apparatus is arranged to determine that the camera images are being displayed on a viewing display. Further, the viewing apparatus is arranged to determine that a viewing operator is present to view the viewing display. In one example embodiment the viewer apparatus comprises a sensor such as an infra-red sensor, which is arranged to receive a signal from a transmitter worn by the viewing operator such as in the form of a headset. In another example, the viewer apparatus comprises a viewing camera arranged to view the viewing operator. Images from the viewing camera are suitably processed such as by using a face detection function or preferably a face recognition function to determine that the viewing operator is viewing the camera images displayed on the viewing display of the viewer apparatus. More specifically, a gaze detection function is employed to determine that a gaze of the viewing operator's eyes is directed toward the viewing display apparatus.

Preferably, the camera apparatus and the viewer apparatus are arranged to communicate over a communications network. The communications network may take any suitable form but in preferred embodiments of the invention comprises a global data network such as the internet. Communication between the camera apparatus and the viewer apparatus suitably occurs under a communication protocol, such as an internet protocol.

This aspect of the invention allows a camera operator or a subject in the presence of the camera apparatus to know whether images from the camera are being viewed at the viewer apparatus, by examining a status of the viewer indicator. In one embodiment, the viewer indicator provides a visual indication, such as a light emitting diode, that is lit when images from the camera are received at the viewer apparatus. In another embodiment, the viewer indicator conveniently emits an audible signal while images are being received at the viewer apparatus.

As one practical example, the camera apparatus is arranged for surveillance of a room such as a meeting room, which it is desired to survey for security purposes when not in use. Here, the viewer indicator of the camera apparatus may provide confirmation to participants of an authorised meeting that the meeting may progress without surveillance.

As a preferred option, it is desired to know an identity of the viewer apparatus receiving the camera images. Preferably, the camera images are receivable by one or more of a plurality of viewer apparatus, and it is desired to know the identity of the or each viewer apparatus receiving the camera images. Suitably, the or each viewer apparatus is arranged to provide the viewer indication signal back to the camera apparatus.

Preferably, the camera comprises a display screen which preferably is provided within a housing of an image capture device of the camera apparatus, to form an integrated unit. Alternatively, the display screen is provided separate to and associated with the camera apparatus. Preferably, the display screen is arranged to display an identity of one or more viewer apparatus that receive the camera images, and preferably a viewing status of each viewer apparatus. This embodiment is useful, for example, in the field of remote teaching where a camera is arranged to view a teacher, and the display allows the teacher to know identities of one or more students currently receiving images from the camera, and preferably a viewing status.

According to a second aspect of the present invention there is provided a camera apparatus, comprising: an image capture device; and a viewer indicator arranged to indicate that a viewer apparatus receives images from the camera apparatus and that a viewing operator views the camera images received by the viewer apparatus.

According to a third aspect of the present invention there is provided a viewer apparatus arranged to receive camera images from a camera apparatus, comprising the following: a viewer indication unit arranged to provide a viewer indication signal for receipt by the camera apparatus, indicating that the camera images are received by the viewer apparatus; a viewing display, wherein the viewer indication signal indicates that the camera images are being displayed on the viewing display; and means to determine that a viewing operator is present to view the viewing display.

Preferably, the viewer indication signal includes an identity of the viewer apparatus and preferably a viewing status. Determination of the presence of an operator may be by various means, such as by using a face detection function, and/or to determine an identity of the viewing operator, such as by using a face recognition function. Preferably, the viewing apparatus is arranged to determine that a gaze of the viewing operator is directed toward the viewing display, using a gaze detection function.

According to a fourth aspect of the present invention there is provided a method for transmitting information relating to transmissin of images, comprising: receiving camera images from a camera apparatus at a viewer apparatus; determining a viewing status of the viewer apparatus, wherein the viewer status indicates whether a viewing operator is present to view a viewing display of the viewer apparatus; and providing to the camera apparatus a viewer indication signal indicating the viewing status of the viewer apparatus and that the camera images are received at the viewer apparatus.

The method preferably comprises determining a status of a viewer indicator of the camera apparatus, in response to the viewer indication signal. The viewer indicator preferably comprises a display and the method comprises the step of displaying an identity and/or viewing status of one or more viewer apparatus that receive the camera images. Suitably, the identity of the viewer apparatus and/or the viewing status are determined at the viewer apparatus and passed to the camera apparatus as part of the viewer indication signal.

### DESCRIPTION OF DRAWINGS

For a better understanding of the invention, and to show how embodiments of the same may be carried into effect, reference will now be made, by way of example, to the accompanying diagrammatic drawing in which:

FIG. 1 is a schematic diagram of a preferred image transmission system.

### DESCRIPTION OF PREFERRED EMBODIMENTS

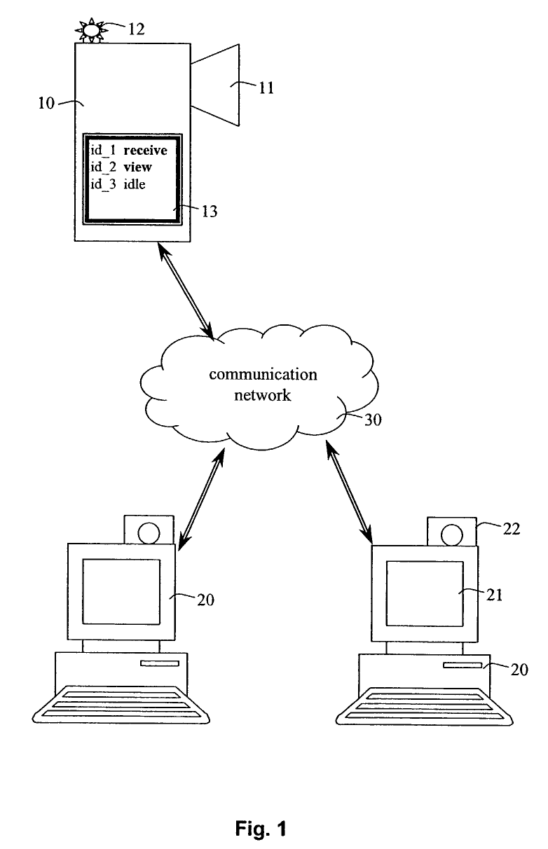

The preferred image transmission system shown FIG. 1 comprises a camera apparatus 10 and a plurality of viewer apparatus 20 linked by a communication network 30.

The camera apparatus 10 may take any suitable form and in this example is a relatively small hand-held apparatus suitable for surveying a general area such as a room or a specific subject such as a user of a computer apparatus. The camera apparatus includes an image capture unit 11 arranged to capture camera images, preferably as a stream of images at regular intervals. The camera images are optionally processed locally by the camera apparatus 10 itself or by a related processing apparatus coupled thereto, such as a general-purpose computer platform (not shown). In use, the camera images are supplied to a communication network 30. The communication network is suitably a private network such as a LAN or WAN, or a public access network such as the internet.

The camera images are received by one or more viewer apparatus 20. Suitably, each viewer apparatus 20 is arranged to provide a viewer indication signal through the communication network 30 back to the camera apparatus 10.

In a first embodiment, the viewer indication signal indicates that the camera images from the camera apparatus 10 are received at the viewer apparatus 20. In response, the camera apparatus 10 provides a viewer indicator. The viewer indicator may take any suitable form and in one simple embodiment comprises a viewer indicator light 12 which is, for example, lit to indicate that the camera images are received at the viewer apparatus 20. This first embodiment of the invention allows a camera operator or a subject in the vicinity of the camera apparatus 10 to know that camera images are being received by a remote viewer apparatus 20.

As a preferred option, the camera apparatus 10 comprises a viewer status display 13. The viewer status display can be provided instead of or additional to the viewer indicator 12. Suitably, the viewer status display 13 comprises an alphanumeric display, such as a liquid crystal display. Conveniently, the viewer status display is arranged within a single housing with the image capture unit 11 to form an integrated device. For example, the viewer status display 13 is arranged on an exterior portion of a housing of the camera apparatus 10. Conveniently, the viewer status display is positioned or is positionable to face in the same direction as the image capture unit 11, such that the viewer status display can be seen by a subject surveyed by the image capture unit 11.

FIG. 1 shows a simplified example of viewer indication signal displayed on the viewer status display 13. Preferably, the viewer status display 13 displays an identity of the or each viewer apparatus 20 arranged to receive camera images from the camera apparatus 10. Also, the viewer status display preferably displays a status for the or each viewer apparatus.

In the example of FIG. 1, a first viewer apparatus with the identity “id_{—1}” is given the status “RECEIVE”. Here, for example, the first viewer apparatus 20 currently receives images from the camera apparatus 10 and stores the camera images for viewing later offline. A second viewer apparatus 20 has the identity “id_2” and is given the status “VIEW”. This viewer apparatus receives and displays live camera images from the camera apparatus 10 to be viewed by a viewing operator of the viewer apparatus 20. A third viewer apparatus with the identity “id_{—3}” does not currently receive the camera images and is shown with the status “IDLE”. In an alternative embodiment, the viewer status display 13 only shows viewer information for viewer apparatus which are currently active. Suitably, the viewer status display 13 is updated regularly, either periodically or in response to a status change at each viewer apparatus.

The or each viewer apparatus 20 may take any suitable form. In the example embodiment of FIG. 1, each viewer apparatus 20 comprises a general-purpose computer platform, including a visual display unit 21 for displaying the camera images received from the camera apparatus 10. The general-purpose computer platform acts as a viewer indication signal unit arranged to form the viewer indication signal sent back to the camera apparatus 10 over the communication network 30.

In a second preferred embodiment of the invention, each viewer apparatus comprises a viewing camera 22 which is arranged to view a viewing operator when in a position to view the camera images displayed on the display unit 21. The viewing camera 22 provides images of the viewing operator that are conveniently processed locally at the viewer apparatus 20, or can be sent back to the camera apparatus 10 for further processing. Suitably, images of the viewing operator are subject to a face detection function to determine the presence of a viewing operator. Preferably, the images of the viewing operator are subject to a face recognition function to also determine the identity of the viewing operator. Further, a gaze recognition function is preferably employed to determine that the gaze of the viewing operator is directed toward the images displayed on the display unit 21.

A function purely for face detection is the CMU (Carnegie Mellon University) face detector described in more detail in “Human Face Detection in Visual Scenes”, Henry A. Rowley, Shumeet Baluja and Takeo Kanade, Carnegie Mellon Computer Science Technical Report CMU-CS-95-158R, November 1995.

One example of an existing function able to identify a face from an image is described in “Beyond Eigenfaces: Probabilistic Matching for Face Recognition”, Moghaddam B., Wahid W. & Pentland A. International Conference on Automatic Face & Gesture Recognition, Nara, Japan, April 1998.

Also, existing functions are able to determine whether an individual is looking at the appliance concerned by means of gaze recognition. An example of a gaze recognition function is disclosed in “3-D Facial Pose and Gaze Point Estimation using a Robust Real-Time Tracking Paradigm”, Jochen Heinzmann & Alexander Zelinsk, International Conference on Automatic Face & Gesture Recognition, Nara, Japan, April 1998.

In any of the embodiments described above, the viewer indication signal returned from the viewer apparatus 20 to the camera apparatus 10 may take any suitable form. In the simplest embodiment, the viewer indication signal indicates that the camera images are being received at the viewer apparatus. Preferably, the viewer indication signal also returns an identity of the viewer apparatus. Further preferably, the viewer indication signal returns a status of the viewer apparatus 20. The status can indicate that the camera images are being displayed for viewing by a viewing operator. In the second preferred embodiment, the viewer indication signal indicates that a viewing operator is present to view the images, and preferably confirms that the gaze of the viewing operator is directed toward the displayed camera images. Where the identity of the viewing operator is recognised, preferably that identity is given in the viewer indication signal. The viewer indication signal is suitably sent as a packet of information, or parts of the signal can be sent as separate packets of information.

Preferably, communication between the or each viewer apparatus 20 and the camera apparatus 10 occurs under a predetermined communications protocol. As one example, communications occur under the ITU Standard H.323 (as an adaptation of H.320). H.323 defines a protocol for communication between terminals (e.g. PCs), equipment, and services for multimedia, over networks that do not provide a guaranteed quality of service (such as the Internet). H.323 terminals and equipment can carry real-time video, voice, and data, or any combination of these elements. The H.323 standard makes use of a number of earlier standards, including H.245 which provides a call control mechanism enabling connection and communication between H.323 compatible terminals. Suitably, the viewer information is sent from the or each viewer apparatus to the camera apparatus under the H.245 standard. Conveniently, the viewer information provides an identity based on an IP address of each viewer apparatus. The identity of the or each viewer apparatus is conveniently matched to an alias (e.g. “Bob” or “Alison”) stored at the camera apparatus, for ease of comprehension by a human camera operator or camera subject. The stored alias is suitably updated to maintain consistency with dynamically allocated IP addresses.

A camera apparatus and a viewer apparatus have each been described for use in an image transfer system. A method of operating the camera apparatus and the viewer apparatus, and a method for transmitting camera images have each been described.

The present invention has many advantages. A subject or camera operator in the vicinity of the camera apparatus is able to know whether camera images are received at a viewer apparatus, through the user of a viewer indicator. Preferred embodiments of the invention allow an identity of each viewer apparatus to be displayed, preferably with a status of each viewer apparatus. Also, the presence, identity and preferably gaze of a viewing operator can be determined. Optionally, a status of the viewer apparatus is determined based on this information, and returned to the camera apparatus. The subject or camera operator in the vicinity of the camera apparatus is able to know the status of the viewer apparatus, including that the camera images are viewed by a recognised viewing operator.

1. An image transmission system, comprising:
a camera apparatus arranged to provide camera images; and
a viewer apparatus arranged to receive the camera images from the camera apparatus and arranged to determine that the camera images are being displayed on a viewing display and that a viewing operator is present to view the viewing display, and in return providing a viewer indication signal indicating that the camera images are received;
wherein the camera apparatus comprises a viewer indicator operable to indicate that camera images are received by the viewer apparatus, the viewer indicator being operable in response to the viewer indication signal from the viewer apparatus.

2. The image transmission system of claim 1, wherein the viewing apparatus is arranged to determine that a viewing operator is present to view the viewing display, using a face detection function.

3. The image transmission system of claim 1, wherein the viewing apparatus is arranged to determine an identity of the viewing operator, using a face recognition function.

4. The image transmission system of claim 1, wherein the viewing apparatus is arranged to determine that a gaze of the viewing operator is directed toward the viewing display, using a gaze detection function.

5. The image transmission system of claim 1, wherein the viewer indicator comprises a display screen provided within a housing of an image capture device of the camera apparatus, to form an integrated unit.

6. The image transmission system of claim 1, wherein the viewer indication signal includes an identity of the viewer apparatus receiving the camera images.

7. The image transmission system of claim 6, wherein the viewer indicator is arranged to display the identity of one or more viewer apparatus that receive the camera images.

8. The image transmission system of claim 1, wherein the viewer indication signal includes a viewing status of the viewer apparatus receiving the camera images.

9. The image transmission system of claim 8, wherein the viewer indicator is arranged to display a viewing status of one or more viewer apparatus that receive the camera images.

10. A camera apparatus, comprising:
an image capture device; and
a viewer indicator arranged to indicate that a viewer apparatus receives images from the camera apparatus and that a viewing operator views the camera images received by the viewer apparatus.

11. The camera apparatus of claim 10, wherein the viewer indicator comprises a display screen provided within a housing of the image capture device, to form an integrated unit.

12. The camera apparatus of claim 10, wherein the viewer indicator is arranged to display an identity of one or more viewer apparatus that receive the camera images.

13. The camera apparatus of claim 10, wherein the viewer indicator is arranged to display a viewing status of one or more viewer apparatus that receive the camera images.

14. The camera apparatus of claim 10, wherein the viewer indicator is arranged to operate in response to a viewer indication signal from one or more viewer apparatus.

15. A viewer apparatus arranged to receive camera images from a camera apparatus, comprising:
a viewer indication unit arranged to provide a viewer indication signal for receipt by the camera apparatus, indicating that the camera images are received by the viewer apparatus;
a viewing display, wherein the viewer indication signal indicates that the camera images are being displayed on the viewing display; and
means to determine that a viewing operator is present to view the viewing display.

16. The viewer apparatus of claim 15, wherein the viewing apparatus is arranged to determine that a viewing operator is present to view the viewing display, using a face detection function.

17. The viewer apparatus of claim 15, wherein the viewing apparatus is arranged to determine an identity of the viewing operator, using a face recognition function.

18. The viewer apparatus of claim 15, wherein the viewing apparatus is arranged to determine that a gaze of the viewing operator is directed toward the viewing display, using a gaze detection function.

19. The viewer apparatus of claim 15, wherein the viewer indication signal includes an identity of the viewer apparatus.

20. The viewer apparatus of claim 15, wherein the viewer indication signal includes a viewing status of the viewer apparatus.

21. A method for transmitting information relating to transmissin of images, comprising:
receiving camera images from a camera apparatus at a viewer apparatus;
determining a viewing status of the viewer apparatus, wherein the viewer status indicates whether a viewing operator is present to view a viewing display of the viewer apparatus; and
providing to the camera apparatus a viewer indication signal indicating the viewing status of the viewer apparatus and that the camera images are received at the viewer apparatus.

22. The method of claim 21, comprising determining that a viewing operator is present to view the viewing display, using a face detection function.

23. The method of claim 21, comprising recognising an identity of a viewing operator who views the viewing display, using a face recognition function, and wherein the viewer status indicates the identity of the viewing operator.

24. The method of claim 21, comprising determining that a gaze of a viewing operator is directed toward the viewing display, using a gaze detection function.

25. The method of claim 21, comprising displaying the viewing status of the viewer apparatus at the camera apparatus.

26. The method of claim 25, wherein the viewer status indicates that the camera images are displayed on a viewing display of the viewer apparatus.

27. The method of claim 21, comprising determining a status of a viewer indicator of the camera apparatus, in response to the viewer indication signal.

28. The method of claim 21, comprising determining an identity of a the viewer apparatus receiving the camera images, and providing the identity of the viewer apparatus in the viewer indication signal.

29. The method of claim 21, comprising displaying the identity of the viewer apparatus, at the camera apparatus.

30. The method of claim 21, comprising receiving the camera images at a plurality of viewer apparatus, and providing the viewer indication signal from each of the plurality of viewer apparatus.
